(19) United States
(12) Patent Application Publication
(10) Pub. No.: US 2026/0006094 A1
(43) Pub. Date: Jan. 1, 2026

(54) SYSTEM AND METHOD FOR PROCESSING OF RESOURCE TRANSFERS USING A DISTRIBUTED REGISTER BASED PEER TO PEER NETWORK

(71) Applicant: BANK OF AMERICA CORPORATION, CHARLOTTE, NC (US)

(72) Inventor: Maharaj Mukherjee, Poughkeepsie, NY (US)

(73) Assignee: BANK OF AMERICA CORPORATION, CHARLOTTE, NC (US)

(21) Appl. No.: 18/760,641

(22) Filed: Jul. 1, 2024

(51) Int. Cl. H04L 67/1074; H04W 24/08; H04W 76/14

(52) U.S. Cl. CPC H04L 67/1078; H04W 24/08; H04W 76/14

(57) ABSTRACT

A system is provided for processing of resource transfers using a distributed register based peer to peer network. In particular, the system may comprise a peer to peer (“P2P”) mesh network comprising a plurality of computing devices forming a shared communication channel with one another. The system may identify the network connection strengths of each of the plurality of wireless computing devices and subsequently designate one or more devices as the hub(s) of the P2P network. The devices within the P2P network may host an encrypted distributed register for storing and processing network requests. In this regard, devices may submit network requests for processing resource transfers to the distributed register to be executed by the one or more hubs of the P2P network. Once all of the devices leave the P2P network, the distributed register is securely erased.

### TECHNOLOGICAL FIELD

Example embodiments of the present disclosure relate to a system and method for processing of resource transfers using a distributed register based peer to peer network.

### BACKGROUND

There is a need for a way to process network requests from computing devices in an efficient manner.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for processing of resource transfers using a distributed register based peer to peer network. In particular, the system may comprise a peer to peer (“P2P”) mesh network comprising a plurality of computing devices forming a shared communication channel with one another. The system may identify the network connection strengths of each of the plurality of wireless computing devices and subsequently designate one or more devices as the hub(s) of the P2P network. The devices within the P2P network may host an encrypted distributed register for storing and processing network requests. In this regard, devices may submit network requests for processing resource transfers to the distributed register to be executed by the one or more hubs of the P2P network. Once all of the devices leave the P2P network, the distributed register is securely erased. In this way, the system provides a secure and efficient way to process resource transfers using the mesh network.

Accordingly, embodiments of the present disclosure provide a system for processing of resource transfers using a distributed register based peer to peer network, the system comprising: a processing device; a non-transitory storage device containing instructions when executed by the processing device, causes the processing device to perform the steps of: establishing, over a wireless communication channel, a peer-to-peer (“P2P”) network, the P2P network comprising a plurality of computing devices; assessing a network connection strength of each of the plurality of computing devices within the P2P network; based on assessing the network connection strength, designating at least one gateway device from the plurality of computing devices within the P2P network; transmitting a data record to a distributed register hosted on each of the plurality of computing devices, wherein the data record comprises a network request comprising one or more online processing tasks to be processed by the at least one gateway device; and determining, based on detecting a completion data record associated with the network request from the distributed register, that the network request has been processed by the at least one gateway device.

In some embodiments, establishing the P2P network comprises: detecting that a peer computing device is within a threshold distance; and creating the P2P network using a unique network ID.

In some embodiments, communications over the wireless communication channel are transmitted and received based on at least one of a Wi-Fi connection, a Bluetooth connection, a DSRC connection, or an NFC connection.

In some embodiments, assessing the network connection strength of each of the plurality of computing devices comprises assessing wireless signal strength, networking bandwidth, latency, wireless connection stability, Internet connection stability, and network transfer speeds of each of the plurality of computing devices.

In some embodiments, the at least one gateway device is designated based on: detecting that the at least one gateway device is unavailable; reassessing the network connection strength of each of the plurality of computing devices; and based on reassessing the network connection strength of each of the plurality of computing devices, designating a replacement gateway device to process the one or more online processing tasks.

In some embodiments, the P2P network is a vehicle-to-vehicle (“V2V”) network.

In some embodiments, the data record comprises data and metadata required to process the network request.

Embodiments of the present disclosure also provide a computer program product for processing of resource transfers using a distributed register based peer to peer network, the computer program product comprising a non-transitory computer-readable medium comprising code causing an apparatus to perform the steps of: establishing, over a wireless communication channel, a peer-to-peer (“P2P”) network, the P2P network comprising a plurality of computing devices; assessing a network connection strength of each of the plurality of computing devices within the P2P network; based on assessing the network connection strength, designating at least one gateway device from the plurality of computing devices within the P2P network; transmitting a data record to a distributed register hosted on each of the plurality of computing devices, wherein the data record comprises a network request comprising one or more online processing tasks to be processed by the at least one gateway device; and determining, based on detecting a completion data record associated with the network request from the distributed register, that the network request has been processed by the at least one gateway device.

In some embodiments, establishing the P2P network comprises: detecting that a peer computing device is within a threshold distance; and creating the P2P network using a unique network ID.

In some embodiments, communications over the wireless communication channel are transmitted and received based on at least one of a Wi-Fi connection, a Bluetooth connection, a DSRC connection, or an NFC connection.

In some embodiments, assessing the network connection strength of each of the plurality of computing devices comprises assessing wireless signal strength, networking bandwidth, latency, wireless connection stability, Internet connection stability, and network transfer speeds of each of the plurality of computing devices.

In some embodiments, the at least one gateway device is designated based on: detecting that the at least one gateway device is unavailable; reassessing the network connection strength of each of the plurality of computing devices; and based on reassessing the network connection strength of each of the plurality of computing devices, designating a replacement gateway device to process the one or more online processing tasks.

In some embodiments, the P2P network is a vehicle-to-vehicle (“V2V”) network.

Embodiments of the present disclosure also provide a computer-implemented method for processing of resource transfers using a distributed register based peer to peer network, the computer-implemented method comprising: establishing, over a wireless communication channel, a peer-to-peer (“P2P”) network, the P2P network comprising a plurality of computing devices; assessing a network connection strength of each of the plurality of computing devices within the P2P network; based on assessing the network connection strength, designating at least one gateway device from the plurality of computing devices within the P2P network; transmitting a data record to a distributed register hosted on each of the plurality of computing devices, wherein the data record comprises a network request comprising one or more online processing tasks to be processed by the at least one gateway device; and determining, based on detecting a completion data record associated with the network request from the distributed register, that the network request has been processed by the at least one gateway device.

In some embodiments, establishing the P2P network comprises: detecting that a peer computing device is within a threshold distance; and creating the P2P network using a unique network ID.

In some embodiments, communications over the wireless communication channel are transmitted and received based on at least one of a Wi-Fi connection, a Bluetooth connection, a DSRC connection, or an NFC connection.

In some embodiments, assessing the network connection strength of each of the plurality of computing devices comprises assessing wireless signal strength, networking bandwidth, latency, wireless connection stability, Internet connection stability, and network transfer speeds of each of the plurality of computing devices.

In some embodiments, the at least one gateway device is designated based on: detecting that the at least one gateway device is unavailable; reassessing the network connection strength of each of the plurality of computing devices; and based on reassessing the network connection strength of each of the plurality of computing devices, designating a replacement gateway device to process the one or more online processing tasks.

In some embodiments, the P2P network is a vehicle-to-vehicle (“V2V”) network.

In some embodiments, the data record comprises data and metadata required to process the network request.

A system is further provided for a self organizing and self correcting autonomic peer to peer network for processing resource transfers. In this regard, the system may restructure the P2P mesh network based on the changes in participating devices within the P2P network, such as when the P2P network is divided into clusters or when clusters merge together. In such embodiments, each cluster may comprise a designated primary device and/or a hub device for processing incoming network requests. The primary device may query the other devices within the cluster for updates and broadcast the updates to each of the other devices within the cluster. The updates may then in turn be stored on each of the devices within the cluster within the distributed register, where the various network requests from the devices may be processed by the hub device of the cluster. In the event that a new primary device is designated within a cluster, the former primary device may establish a secure handshake with the new primary device to ensure that the new primary device is provided with the most up-to-date data for the cluster.

Accordingly, embodiments of the present disclosure provide a system for a for self organizing and self correcting autonomic peer to peer network for processing resource transfers, the system comprising: a processing device; a non-transitory storage device containing instructions when executed by the processing device, causes the processing device to perform the steps of: establishing, over a wireless communication channel, a peer-to-peer (“P2P”) network, the P2P network comprising a plurality of computing devices; detecting a change in a configuration of the P2P network, wherein the change in the configuration of the P2P network comprises at least one of a split of the P2P network into a plurality of sub-clusters or a creation of a merged cluster based on an addition of at least one new computing device to the P2P network; based on detecting the change in the configuration of the P2P network, designating at least one primary device based on at least a location of the at least one primary device; transmitting a data record to the at least one primary device, wherein the data record comprises a network request comprising one or more online processing tasks to be processed by at least one gateway device; and determining, based on detecting a completion data record associated with the network request from a distributed register, that the network request has been processed by the at least one gateway device.

In some embodiments, the change in the configuration of the P2P network comprises a split of the P2P network into a first sub-cluster and a second sub-cluster, wherein designating the at least one primary device comprises designating a first primary device for the first sub-cluster based on the first primary device being centrally located within the first sub-cluster, and designating a second primary device for the second sub-cluster based on the second primary device being centrally located within the second sub-cluster.

In some embodiments, designating the at least one primary device further comprises transferring updated data regarding devices within the first sub-cluster from a former primary device to the first primary device, and transferring updated data regarding devices within the second sub-cluster from the former primary device to the second primary device.

In some embodiments, the change in the configuration of the P2P network comprises a first sub-cluster and a second sub-cluster combining to form the merged cluster, wherein designating the at least one primary device comprises designating a merged primary device for the merged cluster based on the merged primary device being centrally located within the merged cluster.

In some embodiments, designating the at least one primary device further comprises transferring updated data regarding devices within the merged cluster from a first primary device associated with the first sub-cluster and a second primary device associated with the second sub-cluster to the merged primary device.

In some embodiments, the P2P network is a vehicle-to-vehicle (“V2V”) network.

In some embodiments, the data record comprises data and metadata required to process the network request.

Embodiments of the present disclosure also provide a computer program product for a self organizing and self correcting autonomic peer to peer network for processing resource transfers, the computer program product comprising a non-transitory computer-readable medium comprising code causing an apparatus to perform the steps of: establishing, over a wireless communication channel, a peer-to-peer (“P2P”) network, the P2P network comprising a plurality of computing devices; detecting a change in a configuration of the P2P network, wherein the change in the configuration of the P2P network comprises at least one of a split of the P2P network into a plurality of sub-clusters or a creation of a merged cluster based on an addition of at least one new computing device to the P2P network; based on detecting the change in the configuration of the P2P network, designating at least one primary device based on at least a location of the at least one primary device; transmitting a data record to the at least one primary device, wherein the data record comprises a network request comprising one or more online processing tasks to be processed by at least one gateway device; and determining, based on detecting a completion data record associated with the network request from a distributed register, that the network request has been processed by the at least one gateway device.

In some embodiments, the change in the configuration of the P2P network comprises a split of the P2P network into a first sub-cluster and a second sub-cluster, wherein designating the at least one primary device comprises designating a first primary device for the first sub-cluster based on the first primary device being centrally located within the first sub-cluster, and designating a second primary device for the second sub-cluster based on the second primary device being centrally located within the second sub-cluster.

In some embodiments, designating the at least one primary device further comprises transferring updated data regarding devices within the first sub-cluster from a former primary device to the first primary device, and transferring updated data regarding devices within the second sub-cluster from the former primary device to the second primary device.

In some embodiments, the change in the configuration of the P2P network comprises a first sub-cluster and a second sub-cluster combining to form the merged cluster, wherein designating the at least one primary device comprises designating a merged primary device for the merged cluster based on the merged primary device being centrally located within the merged cluster.

In some embodiments, designating the at least one primary device further comprises transferring updated data regarding devices within the merged cluster from a first primary device associated with the first sub-cluster and a second primary device associated with the second sub-cluster to the merged primary device.

In some embodiments, the P2P network is a vehicle-to-vehicle (“V2V”) network.

Embodiments of the present disclosure also provide a computer-implemented method for a self organizing and self correcting autonomic peer to peer network for processing resource transfers, the computer-implemented method comprising: establishing, over a wireless communication channel, a peer-to-peer (“P2P”) network, the P2P network comprising a plurality of computing devices; detecting a change in a configuration of the P2P network, wherein the change in the configuration of the P2P network comprises at least one of a split of the P2P network into a plurality of sub-clusters or a creation of a merged cluster based on an addition of at least one new computing device to the P2P network; based on detecting the change in the configuration of the P2P network, designating at least one primary device based on at least a location of the at least one primary device; transmitting a data record to the at least one primary device, wherein the data record comprises a network request comprising one or more online processing tasks to be processed by at least one gateway device; and determining, based on detecting a completion data record associated with the network request from a distributed register, that the network request has been processed by the at least one gateway device.

In some embodiments, the change in the configuration of the P2P network comprises a split of the P2P network into a first sub-cluster and a second sub-cluster, wherein designating the at least one primary device comprises designating a first primary device for the first sub-cluster based on the first primary device being centrally located within the first sub-cluster, and designating a second primary device for the second sub-cluster based on the second primary device being centrally located within the second sub-cluster.

In some embodiments, designating the at least one primary device further comprises transferring updated data regarding devices within the first sub-cluster from a former primary device to the first primary device, and transferring updated data regarding devices within the second sub-cluster from the former primary device to the second primary device.

In some embodiments, the change in the configuration of the P2P network comprises a first sub-cluster and a second sub-cluster combining to form the merged cluster, wherein designating the at least one primary device comprises designating a merged primary device for the merged cluster based on the merged primary device being centrally located within the merged cluster.

In some embodiments, designating the at least one primary device further comprises transferring updated data regarding devices within the merged cluster from a first primary device associated with the first sub-cluster and a second primary device associated with the second sub-cluster to the merged primary device.

In some embodiments, the P2P network is a vehicle-to-vehicle (“V2V”) network.

In some embodiments, the data record comprises data and metadata required to process the network request.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing system for artificial intelligence-based remediation of computing infrastructure issues using federated and reinforcement learning, in accordance with an embodiment of the disclosure;

FIG. 2A illustrates an exemplary DLT architecture, in accordance with an embodiment of the disclosure;

FIG. 2B illustrates an exemplary transaction object within the DLT architecture, in accordance with an embodiment of the disclosure;

FIG. 3 illustrates a method for artificial intelligence-based remediation of computing infrastructure issues using federated and reinforcement learning, in accordance with an embodiment of the disclosure; and

FIG. 4 illustrates a method for processing resource transfers using a self organizing and self correcting autonomic peer to peer network, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, unique characteristic information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “resource” may refer to a tangible or intangible object that may be used, consumed, maintained, acquired, exchanged, and/or the like by a system, entity, or user to accomplish certain objectives. Accordingly, in some embodiments, the resources may include computing resources such as processing power, memory space, network bandwidth, bus speeds, storage space, electricity, and/or the like. In other embodiments, the resources may include objects such as electronic data files or values, authentication keys (e.g., cryptographic keys), document files, funds, digital currencies, and/or the like.

With the developments in wireless network technology, there has been an increase in the number of network requests from users in transit, such as users who may be traveling in a vehicle (e.g., a car, train, bus, taxi, and/or the like). Such network requests (e.g., navigation requests, resource transfer requests, Internet browsing requests, and/or the like) may be processed over the Internet, for example, using cellular based networks. As the load on the cellular network increases over time, the computing devices connected to the cellular network may compete for increasingly scarce network resources. In such a scenario, the infrastructure of the cellular network may not be adequate to process all of the requests in a timely manner, leading to processing delays and/or timeouts. Accordingly, there is a need for a way to efficiently and expediently process network requests such as resource transfer requests.

To address the above concerns among others, the system described herein provides a way to efficiently and securely process network requests such as resource transfer requests within a P2P network. The P2P network may comprise a plurality of computing devices that are communicatively coupled with one another through a wireless mesh network. In this regard, the plurality of computing devices may be located in the same general geographic area and/or within a defined radius from a point of reference (e.g., within 500 meters, 1000 meters, 1 mile, or the like) such that the computing devices may communicate with one another using local wireless technology (e.g., Wi-Fi, NFC, Bluetooth, dedicated short-range communications or “DSRC”, 5G, 4G, 3G, and/or the like). In some embodiments, the computing devices may be located within a vehicle that may be in motion, such as a car, motorcycle, bicycle, bus, train, and/or the like. In such embodiments, the P2P network may be a vehicle to vehicle (“V2V”) network.

The P2P network may be created by two or more computing devices forming an ad-hoc P2P network with one another. If a P2P network does not currently exist, a first computing device may create the ad-hoc P2P network by assigning a unique identifier to the P2P network. The unique identifier may be an alphanumeric string such as a hash value computed using various seed values (e.g., an identifier of the computing device, time, geographic location, and/or the like). Subsequently, a second computing device may query nearby computing devices to verify whether a P2P network currently exist. Upon detecting the existence of the P2P network, the networking application of the second computing device may request to join the P2P network as a participant.

Once the P2P network has been established, the computing devices may query one another to verify the strength of the network connection of each of the individual computing devices. The strength of the network connection may be determined by the computing devices based on a number of factors, such as the connection stability, wireless signal strength, available bandwidth, latency values, and/or the like. Upon determining the network connection strengths of each of the devices in the P2P network, the system may generate a ranked list of computing devices based on their connection strengths (e.g., with devices being ranked in descending order of network strength). Based on the ranked list, the system may select and designate one or more computing devices to be the “gateway” or “hub” devices through which network traffic will flow to conduct online processes within the P2P network. In some embodiments, the number of designated gateway devices may be selected based at least partially on the number of devices having a connection strength above a designated threshold (e.g., the number of devices that have a viable connection strength) and the total number of devices connected to the P2P network. In embodiments in which the P2P network is a V2V network, the strength of the network connections of the individual participants may change as the participants of the network move in relation to the cellular network towers. Accordingly, the system may continuously reassess the network connection strengths of each of the devices over time such that the gateway designations may be reassigned in real time. In this way, the system may ensure that the network connection of the P2P network is as strong and reliable as possible at all times.

Upon designating the gateway devices, the various devices within the P2P network may transmit a request to process one or more online processes or tasks to the one or more gateway devices, either directly or through one or more intermediate devices depending on the relative distance between the transmitting device and the one or more gateway devices. The request may comprise the data and/or metadata needed to perform the online processes or tasks. In an exemplary embodiment, the online process or task may be a request to execute an online transaction (e.g., a transfer of resources from a source account to a destination account). In such embodiments, the data or metadata needed to execute the online transaction may be included within the request (e.g., destination addresses, account numbers, resource amounts, transfer timeframes, and/or the like).

In some embodiments, each of the participating computing devices of the P2P network may serve as nodes of a distributed register hosted by each of the computing devices. In this regard, the data of the distributed register may be replicated and stored on each of the computing devices. The distributed register may include a sequence of data records, where each data record includes information regarding a request received from a computing device along with the data or metadata needed to process the request. The system may further add data records to the distributed register when network requests are completed. As such, the data records may further comprise a link or reference to the data record containing the original network request, along with a confirmation that the network request has been completed. In some embodiments, the system may further write data records to the distributed register regarding the status of network requests. For instance, if a network request was being processed but later timed out, a data record may be written to the distributed register indicating that the processing of the network request has failed. In other embodiments, a data record may be written to the distributed register when a request has been assigned to a gateway for processing (e.g., the network request is in progress, or “progress data record”).

The distributed register may be stored within an encrypted space of the storage devices of the various computing devices (including the gateway devices) such that the data or metadata within the distributed register may be accessed on a per-needed basis by the devices in the network but may not be accessed, viewed, or modified by the users of such devices. In this way, the system ensures that any sensitive data needed to perform the online processes may be protected in spite of the processing being completed on another device (e.g., the gateway devices) or being stored within other devices (e.g., the nodes of the distributed register). In some embodiments, the distributed register may be a private distributed register in which only authorized and/or authenticated participants (e.g., computing devices with an entity-provided application installed thereon) may be permitted to serve as a node of the distributed register (e.g., store data records, participate in consensus, and/or the like). Once all of the participants leave the P2P or V2V network, the distributed register may be securely wiped from each of the devices.

The gateway devices may process the requests in order in which the data records appear within the distributed register. In this regard, each of the requests may contain the steps of the online process to be completed by the gateway device along with the data and/or metadata needed to perform the steps of the process. In embodiments in which multiple gateway devices are part of the P2P network, the gateway devices may share the processing queue and process the requests in turn in a distributed manner. For example, two gateway devices may each process every other request in a round robin manner. In other embodiments, the requests may be distributed in a weighted manner based on the capabilities of each of the gateway devices. For instance, a gateway device with higher processing power, memory space, networking bandwidth, and/or the like may be proportionally assigned a greater number of requests to be processed.

Once a network request has been processed by the one or more gateway devices, the gateway device that completed the network request may write a data record to the distributed register indicating that the network request has been completed (or “completion data record”). Accordingly, the gateway devices may, upon detecting that either a progress data record or completion data record associated with a particular network request has been written to the distributed register, move onto the next network request in the chain of data records within the distributed register. In this way, the system may avoid duplication of processing of the network requests in the queue.

The system may further dynamically change the configuration of the P2P network in response to changes that may occur within the P2P network. For instance, in cases in which the P2P network is a V2V network, a change in the configuration of the P2P network may include a larger cluster of participants of the V2V network splitting into multiple smaller clusters (e.g., the larger cluster of vehicles may encounter a fork in the road or encounters a stoplight, which causes the cluster to bifurcate into two smaller clusters). In other cases, a plurality of smaller clusters may merge into a larger, combined cluster (e.g., two roads merge into one causing two groups of vehicles to merge into the same road, or multiple clusters come to a standstill at a stoplight).

In such embodiments, the system may designate a primary device per cluster of devices within the P2P network. The primary device may be designated, for instance, as the most geographically centrally located primary device within a particular cluster. The primary device may maintain a list of all devices within its cluster, and thus query the other devices within the cluster for updates and broadcast the updates to the other devices. In this regard, querying the other devices may include the primary device receiving network requests from the other devices and thereafter submitting a proposed data record containing the network request to the other devices to be appended to the distributed register.

The designation of the primary device may change over time as the configuration of the P2P network changes. For instance, the primary device, which may initially be the most centrally located device, may begin to move away from the center of the cluster and eventually leave the cluster. In such a scenario, the system may designate a new primary device. Once the new primary device has been designated, the new primary device may create a secure communication channel with the former primary device to exchange data (e.g., incoming data requests) that the former primary device may have received from the other devices. In this way, the system may ensure that even if the former primary device exits the cluster and disconnects from the P2P network, the new primary device will have the most updated information possible. Further, in some embodiments, the primary device may be separate from the gateway device(s), as the devices with the strongest network connections may not necessarily be the devices that are most centrally located within a particular cluster of devices within the P2P network.

In one embodiment, a cluster of devices may split into a plurality of smaller clusters. In such a scenario, a primary device may be designated for each of the smaller clusters. The process may begin by the current primary device detecting that the overall cluster is beginning to separate into smaller clusters (e.g., by one or more devices traveling further than a threshold distance from the primary device). In some embodiments, the system may predict the formation of new sub-clusters or merging of clusters based on location data (e.g., GPS location data) received from each device as well as navigation plan data (e.g., planned route data).

The primary device may then establish secure communication channels with the new designated primary devices for each cluster (which may be designated by the system based on the proximity of the new devices to the center of the new smaller clusters) to transfer updated data to the new devices. For instance, if the main cluster begins to separate into a first sub-cluster and a second sub-cluster, the primary device may transfer the data related to the devices within the first sub-cluster to a new primary device of the first sub-cluster, and also transfer the data related to the devices within the second sub-cluster to a new primary device of the second sub-cluster. Each new primary device may then update their list of devices within their respective sub-clusters. In some embodiments, the system may further assign new gateway devices per sub-cluster, which may or may not be the same devices as the new primary devices.

On the other hand, when multiple sub-clusters merge into a larger cluster, a new primary device may be designated for the merged cluster. In such a scenario, each of the primary devices for the sub-clusters may establish a secure communication channel with the new primary device to transfer the updated data from their respective sub-clusters (e.g., data regarding resource transfer requests submitted by the devices within the sub-cluster) to the new primary device. The list of devices may then be updated within the new primary device to reflect all of the devices within the newly merged cluster. In this way, the system may ensure that the network requests continue to be processed even when the configuration of the P2P network changes over time.

The system as described herein provides numerous technical advantages over conventional systems for processing network requests and/or resource transfers. For instance, by designating one or more gateway devices per cluster of devices, the system may ensure that network requests may continue to be processed by reducing the wireless interference and network load that may be caused by a large number of devices connecting to the network at a given time. Furthermore, by designating a primary device per cluster of devices, the system may ensure that network requests continue to be processed while minimizing service interruption even when the configuration of the P2P network changes.

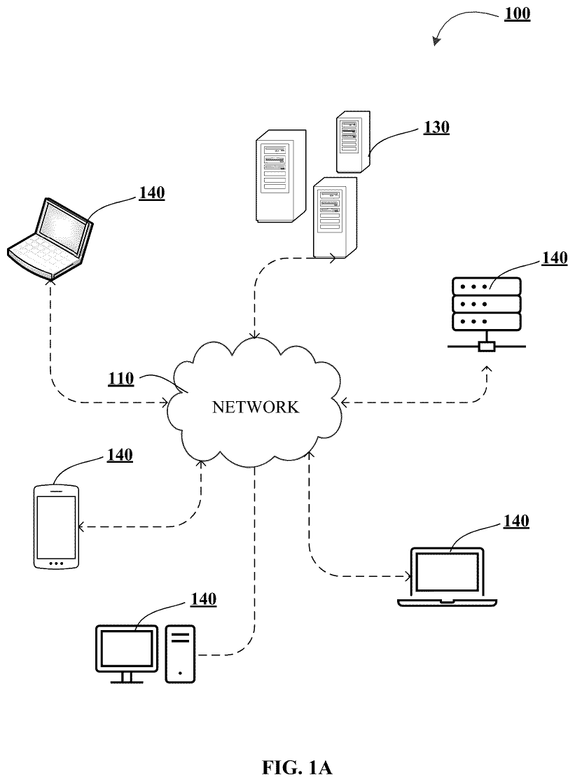

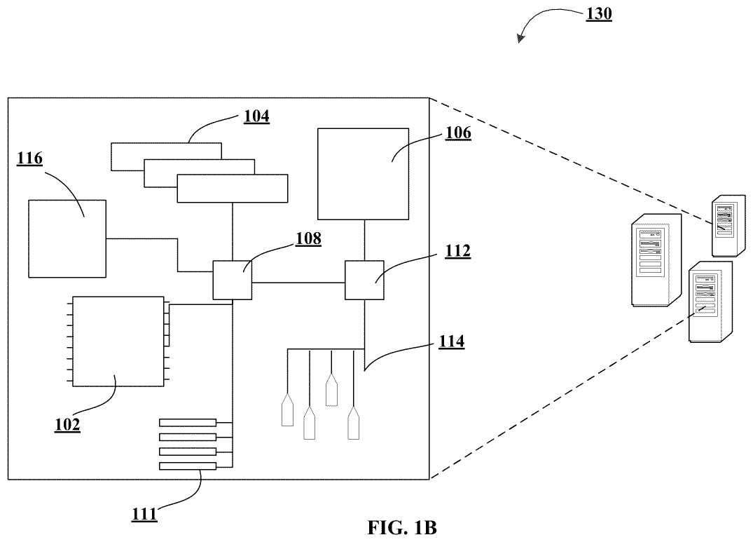

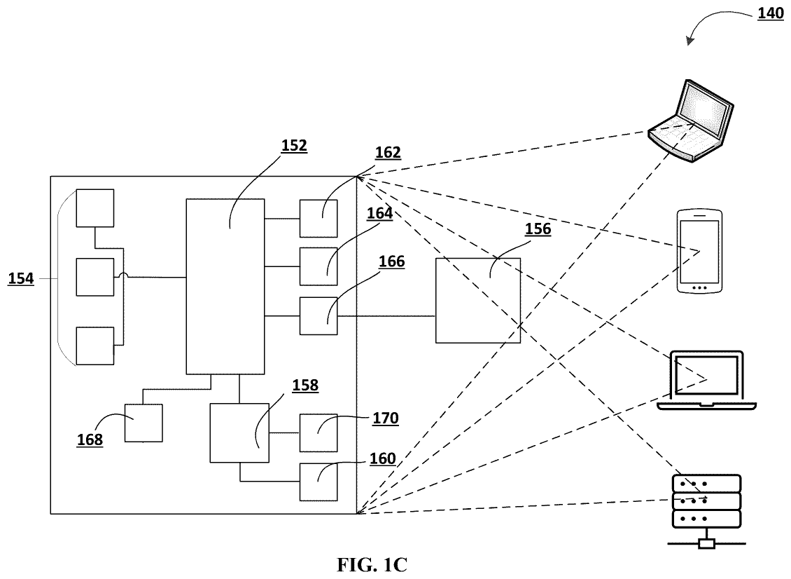

Turning now to the figures, FIGS. 1A-1C illustrate technical components of an exemplary distributed computing environment 100 for the system for processing of resource transfers using a distributed register based peer to peer network. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. For instance, the functions of the system 130 and the endpoint devices 140 may be performed on the same device (e.g., the endpoint device 140). Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it. In some embodiments, the system 130 may provide an application programming interface (“API”) layer for communicating with the end-point device(s) 140.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as servers, networked storage drives, personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102 (which may also be referred to herein as a “processing device”), memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

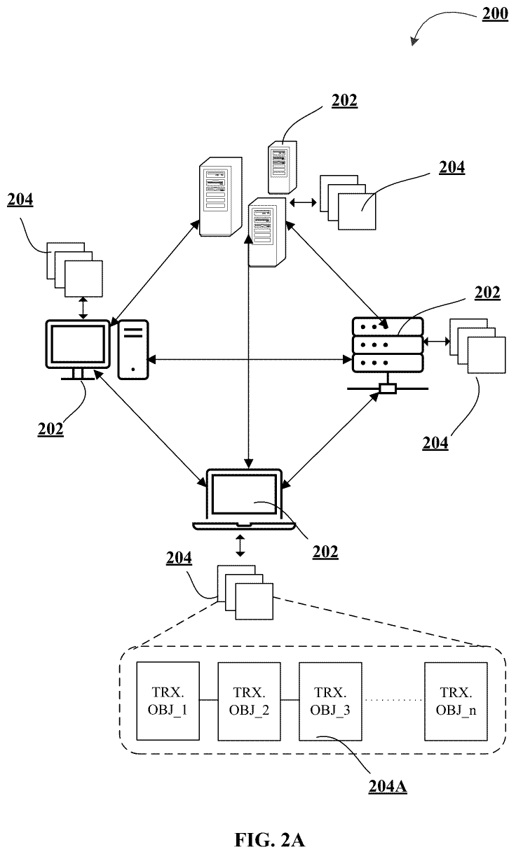

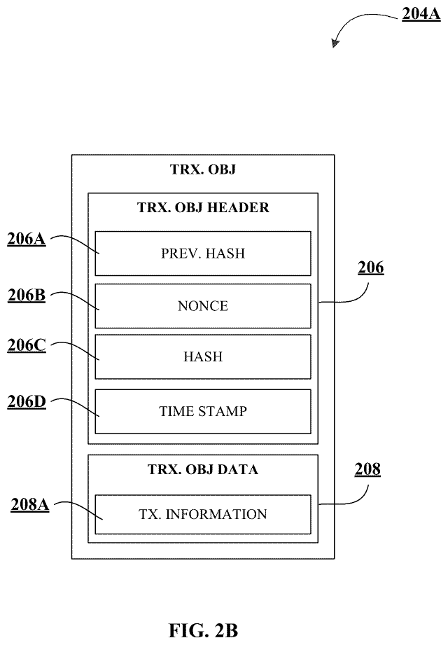

FIGS. 2A-2B illustrate an exemplary distributed ledger technology (DLT) architecture, in accordance with an embodiment of the invention. The distributed ledger may also be referred to herein as a “distributed register.” DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT may use a peer-to-peer protocol for a cryptographically secured distributed ledger of transactions represented as transaction objects (which may also be referred to herein as “data records”) that are linked. In some embodiments, the transaction objects or data records may contain state information about a resource that is tracked by the system. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT may use smart contracts. “Smart contracts” as used herein may refer to computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A “public distributed ledger” as referred to herein may refer to a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, a fully private distributed ledger may be a distributed ledger whereby permissions are kept centralized with one entity. The permissions may be public or restricted to an arbitrary extent. And lastly, a consortium distributed ledger may be a distributed ledger where the consensus process is controlled by a pre-selected set of nodes; for example, a distributed ledger may be associated with a number of member institutions (e.g., 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 2A, the exemplary DLT architecture 200 includes a distributed ledger 204 being maintained on multiple devices (nodes) 202 that are authorized to keep track of the distributed ledger 204. For example, these nodes 202 may be computing devices such as system 130 and client device(s) 140. One node 202 in the DLT architecture 200 may have a complete or partial copy of the entire distributed ledger 204 or set of transactions and/or transaction objects 204A on the distributed ledger 204. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes. The transaction objects 204A may comprise an origin transaction object that may serve as the beginning of a chain of transaction objects, such that transaction objects 204A are added to the end of the chain beginning from the origin transaction object. In some embodiments, a subchain may be formed from any of the transaction objects 204A within the distributed ledger 204, where the subchain may comprise information relating to a specific resource tracked by the system.

As shown in FIG. 2B, an exemplary transaction object 204A may include a transaction header 206 and a transaction object data 208. The transaction header 206 may include a cryptographic hash of the previous transaction object 206A, a nonce 206B-a randomly generated 32-bit whole number when the transaction object is created, cryptographic hash of the current transaction object 206C wedded to the nonce 206B, and a time stamp 206D. The transaction object data 208 may include transaction information 208A being recorded. Once the transaction object 204A is generated, the transaction information 208A is considered signed and forever tied to its nonce 206B and hash 206C. Once generated, the transaction object 204A is then deployed on the distributed ledger 204. At this time, a distributed ledger address is generated for the transaction object 204A, i.e., an indication of where it is located on the distributed ledger 204 and captured for recording purposes. Once deployed, the transaction information 208A is considered recorded in the distributed ledger 204.

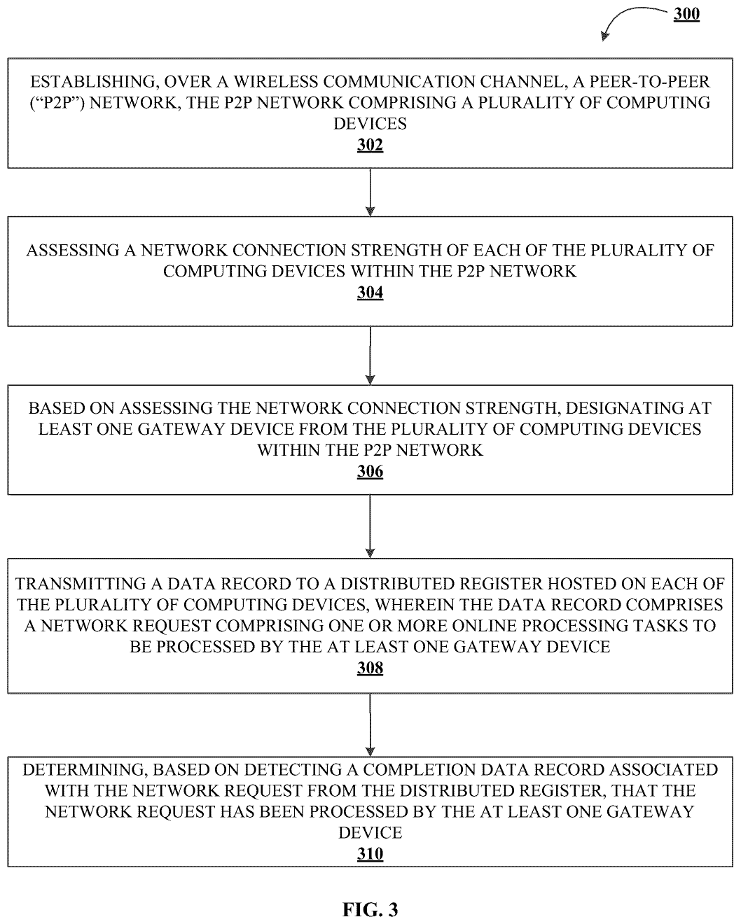

FIG. 3 illustrates a method 300 for processing of resource transfers using a distributed register based peer to peer network. As shown in block 302, the method includes establishing, over a wireless communication channel, a peer-to-peer (“P2P”) network, the P2P network comprising a plurality of computing devices. In some embodiments, the P2P network may be a vehicle-to-vehicle or V2V network in which the computing devices are located in and/or integrated into a vehicle such as a car, train, bus, motorcycle, bicycle, and/or the like. Establishing the P2P network may comprise a first computing device detecting that a second computing device is within a threshold distance (e.g., 100 meters, 500 meters, and/or the like) of the first computing device, and subsequently creating the P2P network using a unique network ID. Subsequently, the first computing device may detect that the second computing device has joined the P2P network.

Next, as shown in block 304, the method includes assessing a network connection strength of each of the plurality of computing devices within the P2P network. The network connection strength of a computing device may be computed based on various factors, such as wireless signal strength, networking bandwidth, latency, wireless connection stability, Internet connection stability, network transfer speeds, and/or the like. In some embodiments, assessing the network connection strength of each of the devices may further comprise generating a ranked list of computing devices within the P2P network ordered by network connection strength.

Next, as shown in block 306, the method includes based on assessing the network connection strength, designating at least one gateway device from the plurality of computing devices within the P2P network. In this regard, the gateway devices may be selected based on which devices have the highest network connection strength. Accordingly, in embodiments, in which multiple gateway devices are selected (e.g., the system designates a second gateway device, and/or a third gateway device, and/or a fourth gateway device, and the like), such gateway devices may be selected in order of their network connection strengths. In some embodiments, the system may select gateway devices based on additional factors, such as processing power, memory space, current processing workload, and/or the like. In the event that a gateway device becomes unavailable, disconnects from the P2P network, or experiences an interruption in the network connection, the system may reassess the network connection strengths of the devices within the P2P network and designate one or more replacement gateway devices based on the reassessed network connection strengths.

Next, as shown in block 308, the method includes transmitting a data record to a distributed register hosted on each of the plurality of computing devices, wherein the data record comprises a network request comprising one or more online processing tasks to be processed by the at least one gateway device. The online processing task may be, for instance, a resource transfer request to transfer resources from a source account to a destination account. In this regard, the data record may further comprise the information needed to process such a request, such as destination account information, source account information, resource amount, resource format, transfer time, and/or the like. The data record may be appended to the distributed register stored across the plurality of computing devices such that each of the plurality of computing devices may store a copy of the data record. In this way, the system may ensure that network requests are processed without being lost within the P2P network.

Next, as shown in block 310, the method includes determining, based on detecting a completion data record associated with the network request from the distributed register, that the network request has been processed by the at least one gateway device. The processing of the network requests within the P2P network may be executed based on the contents of the distributed register. For instance, once a gateway device begins to process a network request (e.g., by the gateway device reading the network request from the data record within the distributed register), the gateway device may transmit a status data record associated with the network request to the distributed register, where the status data record comprises an indication that a particular network request is being processed by the gateway device. Upon completing the network request (e.g., by executing the resource transfer), the gateway device may write a completion data record to the distributed register indicating that the network request has been completed.

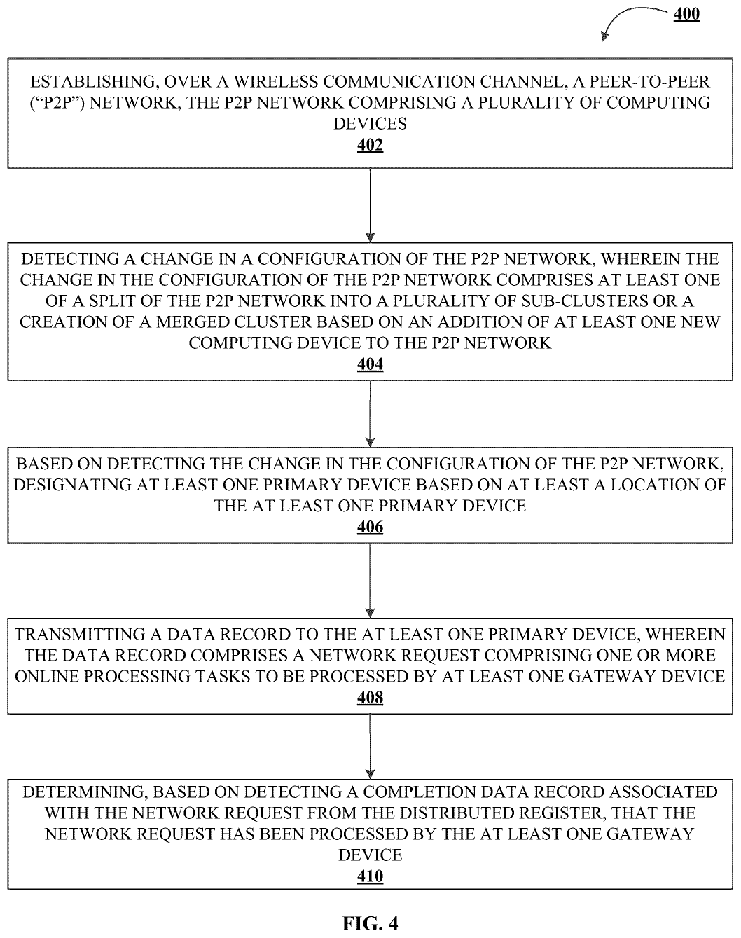

FIG. 4 illustrates a method 400 for processing resource transfers using a self organizing and self correcting autonomic peer to peer network. As shown in block 402, the method includes establishing, over a wireless communication channel, a peer-to-peer (“P2P”) network, the P2P network comprising a plurality of computing devices. As stated above, the P2P network may be in some embodiments a V2V network. As a vehicle and/or groups of vehicles within the P2P network naturally enter and/or exit the P2P network, the system may automatically reorganize and/or reconfigure the P2P network to ensure that network requests continue to be processed despite the configuration changes, as provided in further detail below and elsewhere herein.

Next, as shown in block 404, the method includes detecting a change in a configuration of the P2P network, wherein the change in the configuration of the P2P network comprises at least one of a split of the P2P network into a plurality of sub-clusters or a creation of a merged cluster based on an addition of at least one new computing device to the P2P network. In some embodiments, the larger cluster of devices may split into two or more sub-clusters (e.g., when the cluster of vehicles bifurcates due to a fork in the road). In other embodiments, multiple sub-clusters may combine to form a larger cluster (e.g., when two roads merge into one). In both scenarios, the system may designate at least one primary device and/or at least one gateway device per cluster of devices to ensure that network requests continue to be processed.

Next, as shown in block 406, the method includes, based on detecting the change in the configuration of the P2P network, designating at least one primary device based on at least a location of the at least one primary device. In embodiments in which a larger cluster splits into two or more sub-clusters, the system may designate at least one primary device per sub-cluster (e.g., a first primary device for the first sub-cluster and a second primary device for the second sub-cluster). In this regard, the new primary device per sub-cluster may be designated based on the primary device being the most centrally located within the sub-cluster. The former primary device may establish a secure communication channel with each of the new primary devices and transmits updated information regarding the devices within the sub-cluster to the new primary devices (e.g., information regarding the devices in the first sub-cluster will be transmitted to the first primary device, and the like).

In embodiments in which multiple sub-clusters merge into a larger cluster, the system may designate a primary device based on the device being the most centrally located within the larger cluster. In such a scenario, the former primary devices for each cluster may transmit updated information about the plurality of devices to the newly designated primary device. In some embodiments, the primary device for each cluster may also serve as a gateway device. In other embodiments, the system may designate at least one other device to serve as the gateway device on a per-cluster basis. In this way, each cluster may continue to process network requests.

Next, as shown in block 408, the method includes transmitting a data record to the at least one primary device, wherein the data record comprises a network request comprising one or more online processing tasks to be processed by at least one gateway device. The primary device, which maintains a list of all devices within its cluster, may then transmit the data record to each of the devices within the cluster. Accordingly, the data records may be appended sequentially to each of the copies of the distributed register on each of the devices within the cluster, thereby establishing a durable record of all of the network requests received and/or processed within each cluster.

Next, as shown in block 410, the method includes determining, based on detecting a completion data record associated with the network request from the distributed register, that the network request has been processed by the at least one gateway device. By writing the completion data records and/or the status data records to the distributed register, the system may ensure that no network requests are lost while preventing duplication of processing. In this way, the system may provide a way to continue processing network requests even when the configuration of the P2P network changes over time.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for processing of resource transfers using a distributed register based peer to peer network, the system comprising:
a processing device;
a non-transitory storage device containing instructions when executed by the processing device, causes the processing device to perform the steps of:
establishing, over a wireless communication channel, a peer-to-peer (“P2P”) network, the P2P network comprising a plurality of computing devices;
assessing a network connection strength of each of the plurality of computing devices within the P2P network;
based on assessing the network connection strength, designating at least one gateway device from the plurality of computing devices within the P2P network;
transmitting a data record to a distributed register hosted on each of the plurality of computing devices, wherein the data record comprises a network request comprising one or more online processing tasks to be processed by the at least one gateway device; and
determining, based on detecting a completion data record associated with the network request from the distributed register, that the network request has been processed by the at least one gateway device.

2. The system of claim 1, wherein establishing the P2P network comprises:
detecting that a peer computing device is within a threshold distance; and
creating the P2P network using a unique network ID.

3. The system of claim 1, wherein communications over the wireless communication channel are transmitted and received based on at least one of a Wi-Fi connection, a Bluetooth connection, a DSRC connection, or an NFC connection.

4. The system of claim 1, wherein assessing the network connection strength of each of the plurality of computing devices comprises assessing wireless signal strength, networking bandwidth, latency, wireless connection stability, Internet connection stability, and network transfer speeds of each of the plurality of computing devices.

5. The system of claim 1, wherein the at least one gateway device is designated based on:
detecting that the at least one gateway device is unavailable;
reassessing the network connection strength of each of the plurality of computing devices; and
based on reassessing the network connection strength of each of the plurality of computing devices, designating a replacement gateway device to process the one or more online processing tasks.

6. The system of claim 1, wherein the P2P network is a vehicle-to-vehicle (“V2V”) network.

7. The system of claim 1, wherein the data record comprises data and metadata required to process the network request.

8. A computer program product for processing of resource transfers using a distributed register based peer to peer network, the computer program product comprising a non-transitory computer-readable medium comprising code causing an apparatus to perform the steps of:
establishing, over a wireless communication channel, a peer-to-peer (“P2P”) network, the P2P network comprising a plurality of computing devices;
assessing a network connection strength of each of the plurality of computing devices within the P2P network;
based on assessing the network connection strength, designating at least one gateway device from the plurality of computing devices within the P2P network;
transmitting a data record to a distributed register hosted on each of the plurality of computing devices, wherein the data record comprises a network request comprising one or more online processing tasks to be processed by the at least one gateway device; and
determining, based on detecting a completion data record associated with the network request from the distributed register, that the network request has been processed by the at least one gateway device.

9. The computer program product of claim 8, wherein establishing the P2P network comprises:
detecting that a peer computing device is within a threshold distance; and
creating the P2P network using a unique network ID.

10. The computer program product of claim 8, wherein communications over the wireless communication channel are transmitted and received based on at least one of a Wi-Fi connection, a Bluetooth connection, a DSRC connection, or an NFC connection.

11. The computer program product of claim 8, wherein assessing the network connection strength of each of the plurality of computing devices comprises assessing wireless signal strength, networking bandwidth, latency, wireless connection stability, Internet connection stability, and network transfer speeds of each of the plurality of computing devices.

12. The computer program product of claim 8, wherein the at least one gateway device is designated based on:
detecting that the at least one gateway device is unavailable;
reassessing the network connection strength of each of the plurality of computing devices; and
based on reassessing the network connection strength of each of the plurality of computing devices, designating a replacement gateway device to process the one or more online processing tasks.

13. The computer program product of claim 8, wherein the P2P network is a vehicle-to-vehicle (“V2V”) network.

14. A computer-implemented method for processing of resource transfers using a distributed register based peer to peer network, the computer-implemented method comprising:
establishing, over a wireless communication channel, a peer-to-peer (“P2P”) network, the P2P network comprising a plurality of computing devices;
assessing a network connection strength of each of the plurality of computing devices within the P2P network;
based on assessing the network connection strength, designating at least one gateway device from the plurality of computing devices within the P2P network;
transmitting a data record to a distributed register hosted on each of the plurality of computing devices, wherein the data record comprises a network request comprising one or more online processing tasks to be processed by the at least one gateway device; and
determining, based on detecting a completion data record associated with the network request from the distributed register, that the network request has been processed by the at least one gateway device.

15. The computer-implemented method of claim 14, wherein establishing the P2P network comprises:
detecting that a peer computing device is within a threshold distance; and
creating the P2P network using a unique network ID.

16. The computer-implemented method of claim 14, wherein communications over the wireless communication channel are transmitted and received based on at least one of a Wi-Fi connection, a Bluetooth connection, a DSRC connection, or an NFC connection.

17. The computer-implemented method of claim 14, wherein assessing the network connection strength of each of the plurality of computing devices comprises assessing wireless signal strength, networking bandwidth, latency, wireless connection stability, Internet connection stability, and network transfer speeds of each of the plurality of computing devices.

18. The computer-implemented method of claim 14, wherein the at least one gateway device is designated based on:
detecting that the at least one gateway device is unavailable;
reassessing the network connection strength of each of the plurality of computing devices; and
based on reassessing the network connection strength of each of the plurality of computing devices, designating a replacement gateway device to process the one or more online processing tasks.

19. The computer-implemented method of claim 14, wherein the P2P network is a vehicle-to-vehicle (“V2V”) network.

20. The computer-implemented method of claim 14, wherein the data record comprises data and metadata required to process the network request.
